(19) United States
(12) Patent Application Publication
(10) Pub. No.: US 2024/0348930 A1
(43) Pub. Date: Oct. 17, 2024

(54) Exposure Control for Image-Capture

(71) Applicant: Google LLC, Mountain View, CA (US)

(72) Inventors: Yichang Shih, Cupertino, CA (US); Jinglun Gao, San Mateo, CA (US); Ruben Manuel Velarde, Chula Vista, CA (US); Szepo Robert Hung, Austin, TX (US)

(21) Appl. No.: 18/294,093

(22) PCT Filed: Aug. 2, 2021
(86) PCT No.: PCT/US2021/044185

§ 371 Date: Jan. 31, 2024

(51) Int. Cl. H04N 23/73; H04N 23/63; H04N 23/71; H04N 23/72; H04N 23/745; H04N 23/90

(52) U.S. Cl. CPC H04N 23/73; H04N 23/63; H04N 23/71; H04N 23/72; H04N 23/745; H04N 23/90

(57) ABSTRACT

This document describes techniques and apparatuses for exposure control for image-capture. The techniques and apparatuses utilize sensor data to analyze a scene and, based on this analysis, determine a likelihood of exposure-related defects in captured images of the scene. Based on this likelihood, the techniques determine multiple different exposure times for multiple image-capture devices. An image-merging module then combines these different images captured with different exposure times to create a single image with reduced exposure-related defects.

### BACKGROUND

Mobile computing devices often include image-capture devices, such as cameras that use complementary metal-oxide-semiconductor (CMOS) sensors, to capture an image of a scene. While the quality of the images captured continues to improve, there are numerous challenges with conventional image-capture devices. For example, some image-capture devices fail to capture an adequate image of a scene when elements within the scene are moving. Some solutions may be used to improve image quality in a single aspect, but these solutions often create additional image-quality problems.

### SUMMARY

This document describes techniques and apparatuses for exposure control for image-capture. The techniques and apparatuses utilize sensor data to analyze a scene and, based on this analysis, determine a likelihood of exposure-related defects in a scene to be captured by one or more image-capture devices. Based on this likelihood, the techniques determine multiple different exposure times for the multiple image-capture devices. An image-merging module then combines different images captured with different exposure times to create a single image with reduced exposure-related defects.

In aspects, a method for exposure control in a computing device is disclosed. The method includes an exposure-control apparatus utilizing captured sensor data to determine a likelihood of exposure-related defects in the scene to be captured by one or more image-capture devices. These exposure-related defects can include but are not limited to, blur defects, where the image capture appears blurred in portions of the image capture, and noise defects, where portions of the image capture may appear noisy or less crisp. Such noise defects may be referred to herein as high-noise defects.

In aspects, the exposure control apparatus may determine a first exposure time to decrease the blur defect and a second exposure time, the second exposure time longer than the first exposure time, to decrease the high-noise defect based on the determined likelihood of exposure-related defects. In addition, the exposure control apparatus may cause a first image-capture device of the one or more image-capture devices to capture a first image of the scene using the first exposure time. The exposure control apparatus may also cause a second image-capture device of the one or more image-capture devices to capture a second image of the scene using the second exposure time.

In aspects, the first and second image captures may be provided to an image-merging module. The image-merging module may receive the one or more images and utilize them to create a single image from the one or more image captures of the scene.

Through use of the techniques and apparatuses described herein, exposure control for an image-capture device may be used to minimize exposure-related defects in a single image created from multiple image captures.

This Summary is provided to introduce simplified concepts of techniques and apparatuses for multi-camera exposure control, the concepts of which are further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of exposure control for image-capture are described below. The use of the same reference numbers in different instances in the description and the figures indicate similar elements:

FIG. 1 illustrates an example implementation of a computing device performing exposure control for an image-capture device;

FIG. 2 illustrates an aspect of an image-merging module for the example implementation of FIG. 1;

Fig. 3 illustrates an example operating environment in which exposure control for an image-capture device may be implemented;

FIG. 4 illustrates multiple examples of the sensors that can be used to collect sensor data;

FIG. 5 illustrates an example implementation of a motion-scene aspect of exposure control for an image-capture device;

FIG. 6 illustrates an aspect of an image-merging module of the motion-scene implementation of FIG. 5;

FIG. 7 illustrates an example implementation of an anti-banding aspect of exposure control for an image-capture device;

FIG. 8 illustrates an aspect of an image-merging module for the anti-banding implementation of FIG. 7; and

FIG. 9 illustrates an example method of exposure control for an image-capture device.

While features and concepts of the described techniques and apparatuses for exposure control for image-capture can be implemented in any number of different environments, aspects are described in the context of the following examples.

### DETAILED DESCRIPTION

### Overview

This document describes techniques and apparatuses for exposure control for image-capture. The exposure control described herein may utilize captured sensor data to determine a likelihood of exposure-related defects, which may allow an exposure controller to determine one or more exposure times with which to capture images.

For example, the exposure controller may utilize captured sensor data to determine a likelihood of exposure-related defects, including blur and high-noise defects, in a scene to be captured by one or more image-capture devices. The exposure controller may determine a first exposure time to decrease the blur defect and a second, longer exposure time to decrease the high-noise defect based on the determined likelihood of exposure-related defects. Using the determined first and second exposure times, the exposure controller causes a first and a second image-capture device to capture a first image of the scene using the first exposure time and a second image of the scene using a second exposure time. The exposure controller may then provide the one or more image captures to an image-merging module, which may use the one or more image captures to create a single image of the scene. In this way, the exposure controller decreases exposure-related defects.

While features and concepts of the described techniques and apparatuses for exposure control for an image-capture device can be implemented in any number of different environments, aspects are described in the context of the following examples.

### Example Devices

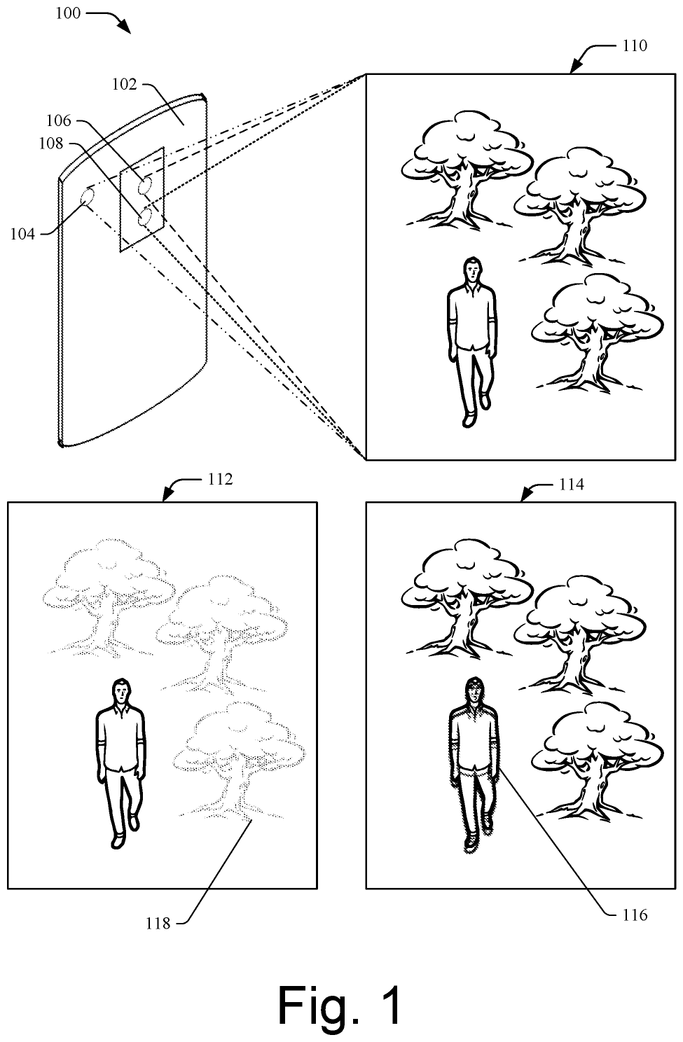

FIG. 1 illustrates an example implementation 100 of a computing device 102, which performs exposure control for an image-capture device in accordance with the techniques described herein. The computing device 102 illustrated may include one or more sensors 104, a first image-capture device 106, and a second image-capture device 108. As illustrated, the computing device 102 is used to capture a scene to be captured 110. The scene to be captured 110 may be captured by one or more image-capture devices (e.g., the first image-capture device 106 and the second image-capture device 108), which may capture one or more images (e.g., a first image 112 and a second image 114). The first image 112 or the second image 114 may contain an exposure-related defect, including a blur defect 116 and a high-noise defect 118.

The computing device 102 includes, or is associated with, one or more sensors 104 to capture sensor data, which may be used to determine a likelihood of exposure-related defects in the scene to be captured 110. Example exposure-related defects include the blur defect 116 and the high-noise defect 118, though others may also exist, such as banding defects noted below.

While not required, the techniques may determine a likelihood of exposure-related defects using machine learning based on previous image captures. For example, the use of machine learning may include supervised or unsupervised learning through use of neural networks, including perceptron, feedforward neural networks, convolutional neural networks, radial basis function neural networks, or recurrent neural networks. For example, the likelihood of exposure-related defects may be determined through supervised machine learning. In supervised machine learning, a labeled set of previous image captures identifying features associated with the image can be given to build the machine-learning model, such as non-imaging data (e.g., accelerometer data, flicker sensor data) and imaging data, labeled based on their exposure-related defect (e.g., a blur defect, a high-noise defect, or a banding defect). Through this supervised machine learning, future image captures may be classified by their exposure-related defect based on relevant features. Further, the future image captures may be fed back into the data set to further train the machine-learning model.

Alternatively, or in addition to machine learning, the techniques may determine the likelihood of exposure-related defects through a weighted equation or through a decision tree based on the captured sensor data.

In the example implementation 100, two image-capture devices (e.g., the first image-capture device 106 and the second image-capture device 108) capture the images (e.g., the first image 112 and the second image 114) of the scene to be captured using a first exposure time and a second, longer exposure time, respectively. One or more additional image-capture devices, however, may be used to capture one or more additional image captures of the scene to be captured 110.

A sensor gain of the image-capture devices may be adjusted to capture each image at a same or similar brightness. The brightness of an image capture is defined as the gain value multiplied by the exposure time. In one example, the second image-capture device 108, using the second, longer exposure time, would capture the second image 114 at a lower gain value to capture the first image 112 and the second image 114 at the same brightness value.

Also, the one or more image-capture devices may be used to capture one or more multi-frame image captures. The one or more multi-frame image captures may be captured in quick succession to allow for an image playback device to create a video from the multi-frame images.

The image-capture devices 106 and 108 can be of various types, such as a wide-angle image-capture device, a telephoto image-capture device, an infrared-image-capture device, and so forth.

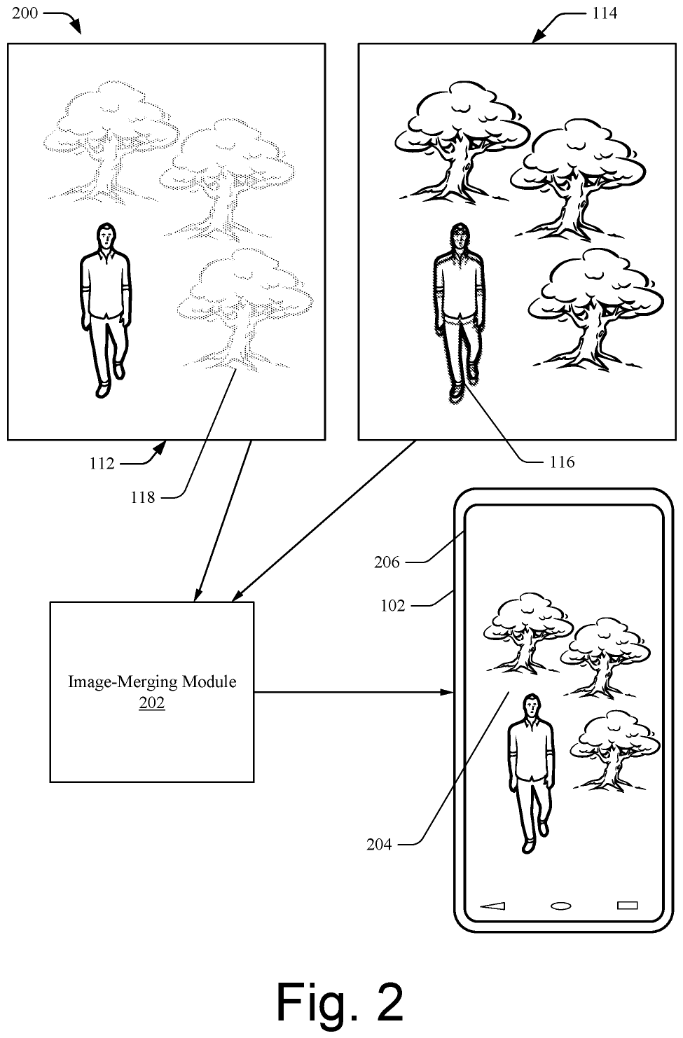

FIG. 2 illustrates an example implementation 200 of an image-merging module 202 used in the computing device 102 of FIG. 1. As illustrated, the image-merging module 202 incorporates both the first image 112 and the second image 114, or portions thereof, to create a single image 204 of a scene to be captured (e.g., scene to be captured 110). The single image 204 may be digitally displayed on a display 206 of the computing device 102, provided to another device, and/or stored.

As noted, the image-merging module 202 uses the first image 112 for a portion of the scene to be captured (e.g., scene to be captured 110), which was determined to have a likelihood of the blur defect 116 and the second image 114 for a portion of the scene to be captured (e.g., scene to be captured 110), which was determined to have the high-noise defect 118. In so doing, the image-merging module 202 creates the single image 204 with decreased exposure-related defects from the image captures. FIG. 2 also illustrates an example in which the single image 204 may be digitally displayed on the display 206 of the computing device 102. The image-merging module 202 may be provided additional images captures of the scene (e.g., scene to be captured 110). The image-merging module may then use the additional images in combination with the first image 112 and second image 114 to create the single image 204 of the scene (e.g., scene to be captured 110). In another aspect, the image-merging module 202 may be provided multi-frame images. The image-merging module 202 may then be used to create a single multi-frame image from the multi-frame images.

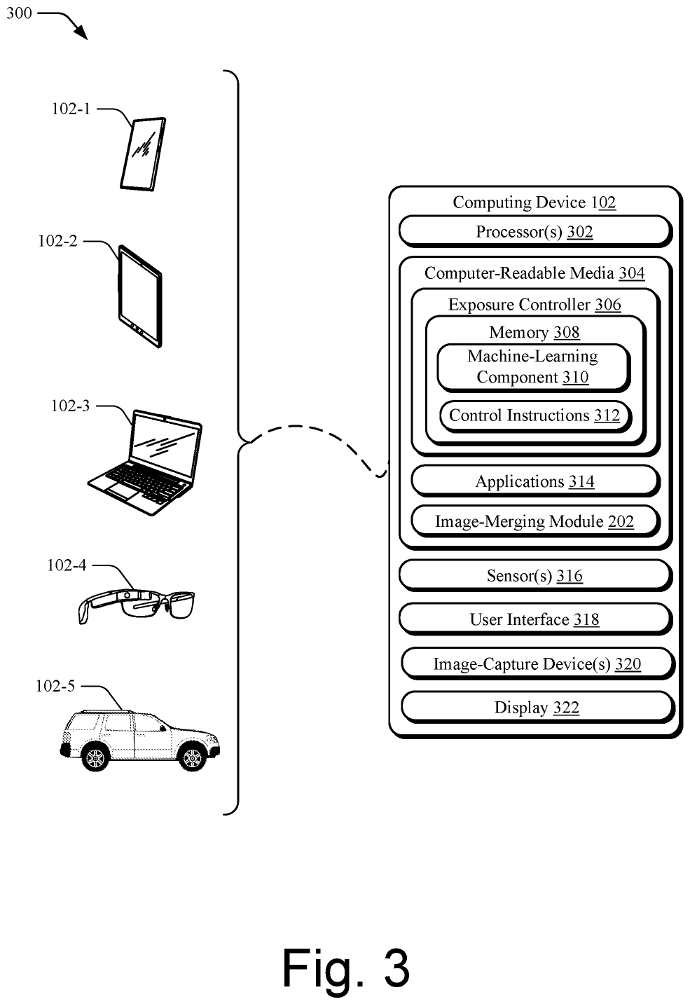

FIG. 3 illustrates an example operating environment 300 in which exposure control for an image-capture device may be implemented. While this document discloses certain aspects of exposure control for an image-capture device performed on a mobile device (e.g., smartphone), it should be noted that exposure control for an image-capture device may be performed using any computing device, including but not limited to: a mobile computing device 102-1; a tablet 102-2; a laptop or personal computer 102-3; imaging eyewear 102-4; vehicles 102-5; and the like.

The example operating environment 300 illustrated in FIG. 3 includes: one or more processors 302; computer-readable media 304; one or more sensors 316 capable of capturing sensor data; a user interface 318; one or more image-capture devices 320; and a display 322. The computer-readable media 304 may contain an exposure controller 306 as described in this document. The exposure controller 306 may include memory 308, which may incorporate a machine learning component 310 and store control instructions 312 that, when executed by the processors 302, cause the processors 302 to implement the method of exposure control for an image-capture device as described in this document. Additionally, the computer-readable media 304 may include the image merging-module 202 and applications 314, such as an image-capture application or an image-display application, which may work in cooperation with the method of exposure control for an image-capture device as described in this document.

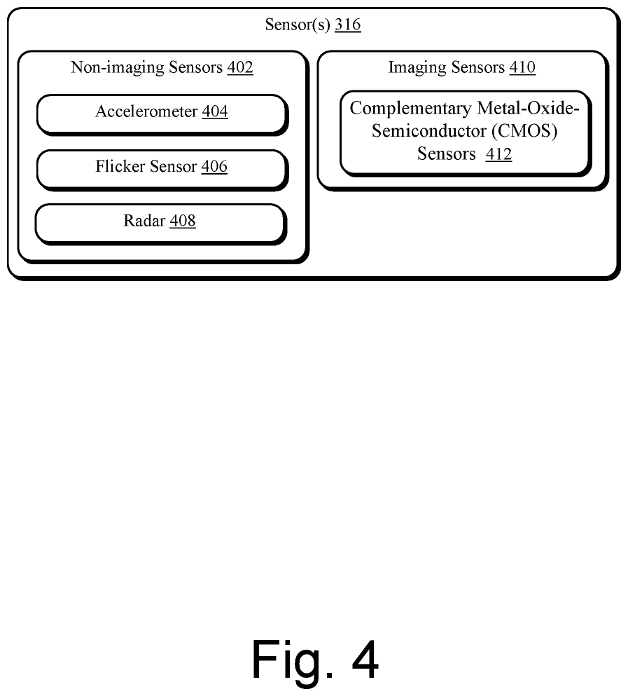

FIG. 4 illustrates multiple examples of the sensors 316 that can be used to collect sensor data. For example, the computing device (e.g., computing device 102) may contain imaging sensors 410 or non-imaging sensors 402. The imaging sensors 410 may contain adjustable gain values and include Complementary Metal-Oxide-Semiconductor (CMOS) Sensors 412 or the like. Similarly, the non-imaging sensors 402 may also contain adjustable gain values and include: an accelerometer 404; a flicker sensor 406; a radar system 408 capable of determining movement in a scene to be captured; or any other sensor capable of providing sensor data to determine the likelihood of exposure-related defects.

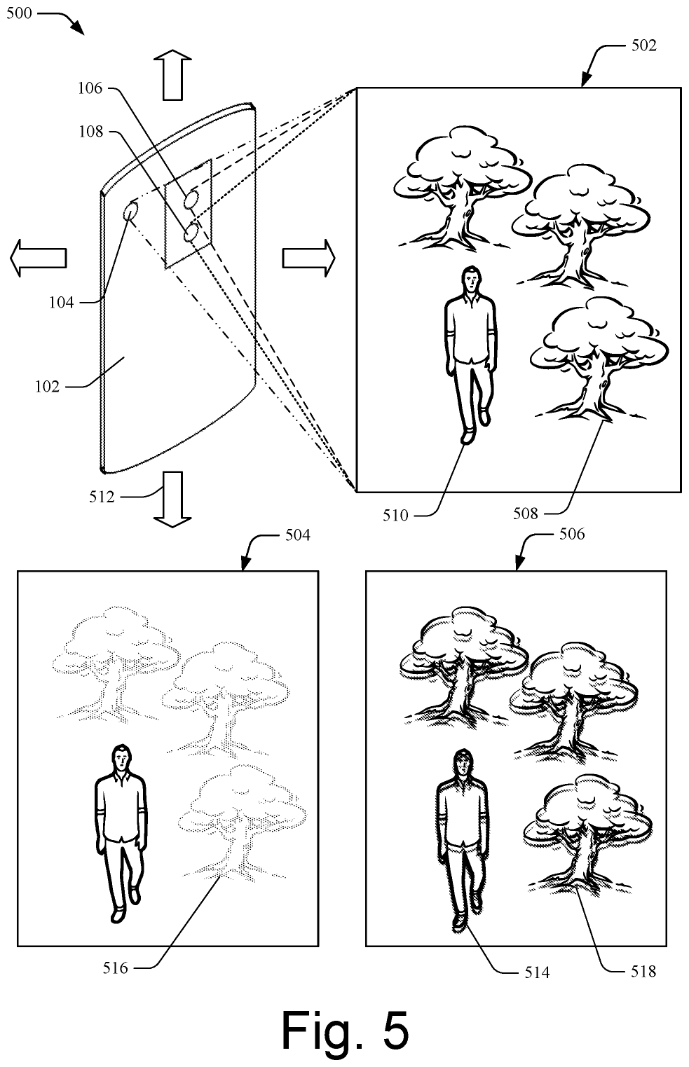

FIG. 5 illustrates an example implementation 500 of a motion-scene aspect of exposure control for an image-capture device. As illustrated, the computing device 102 may utilize sensors 104, the first image-capture device 106, and the second image-capture device 108 to capture a first image 504 and a second image 506 of a scene to be captured 502. The scene to be captured 502 may include a portion identified as a background 508 and a portion identified as an object of focus 510. Additionally, the motion-scene 518 may be created due to the relative motion 512 of the computing device 102 with respect to a portion of the scene to be captured 502.

In this implementation, the image-capture devices may be moving relative to a portion of the scene to be captured 502. In FIG. 5, the relative motion 512 is indicated by arrows. The sensors 104 collect sensor data describing the scene to be captured 502, which is then used by the exposure controller 306 to determine a likelihood of exposure-related defects. The sensor data may also be used, however, to identify an object of focus 510 within the scene to be captured 502 Additionally, the computing device 102 may use the sensor data to identify a remaining portion of the scene to be captured 502 as a background portion 508.

In the example implementation 500 of exposure control for an image-capture device, the computing device 102 utilizes two image-capture devices (e.g., the first image-capture device 106 and the second image-capture device 108). The first image-capture device 106 captures a first image 504 of the scene to be captured 502 using a first exposure time determined based on the determined likelihood of exposure-related defects. The first exposure time is determined to decrease a blur defect 514 in the scene to be captured 502, such as by being a fast exposure. The speed of the exposure can be related to a magnitude of the determined blur defect 514, such as by having a faster exposure for a higher blur (e.g., the faster the movement, the faster the exposure).

Similarly, the second image-capture device 108 captures the second image 506 of the scene to be captured 502 using a second, longer exposure time determined based on the likelihood of exposure-related defects. The second exposure time is determined to decrease a noise defect 516 in the scene to be captured 502. Additionally, the second image may include a motion-scene 518 in the background portion 508 of the scene to be captured 502, the motion-scene 518 being a blurred image-capture indicating motion within the scene to be captured 502. In this case, the inclusion of the motion-scene 518 creates a realistic indication of motion within the scene to be captured 502.

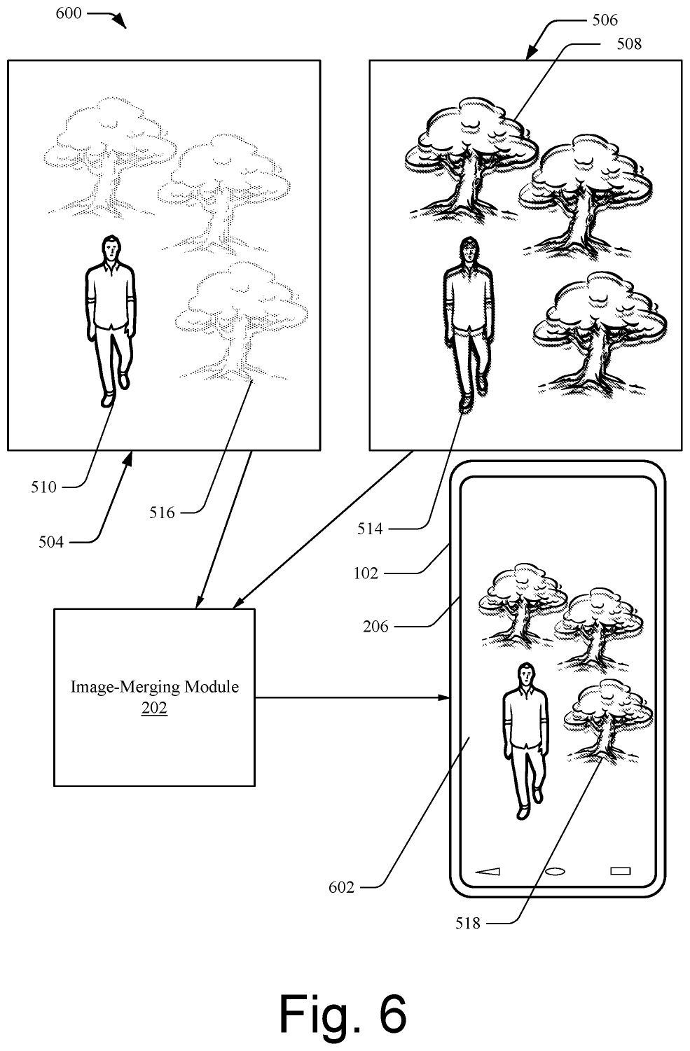

FIG. 6 illustrates an example aspect 600 of the image-merging module 202 for the motion-scene implementation 500 of FIG. 5. As illustrated, the image-merging module 202 receives and incorporates the first image 504 for the object of interest 510 to decrease the blur defect 514 and the second image 506 for the background portion 508 to decrease a noise defect 516 and create the motion-scene 518 in a single image 602 of the scene to be captured (e.g., scene to be captured 502). The single image 602 of the scene to be captured (e.g., scene to be captured 502) may be digitally displayed, provided, and so forth (e.g., displayed on the display 206 of the computing device 102).

In more detail, the image-merging module 202 creates the single image 602 of the scene to be captured (e.g., scene to be captured 502) by incorporating the first image 504 for the object of focus 510 and incorporating the second image 506 for a remaining background portion 508 of the scene to be captured (e.g., scene to be captured 502). As illustrated, the single image 602 has reduced the noise defect 516 and the blur defect 514 while showing the motion of the scene at motion-scene 518.

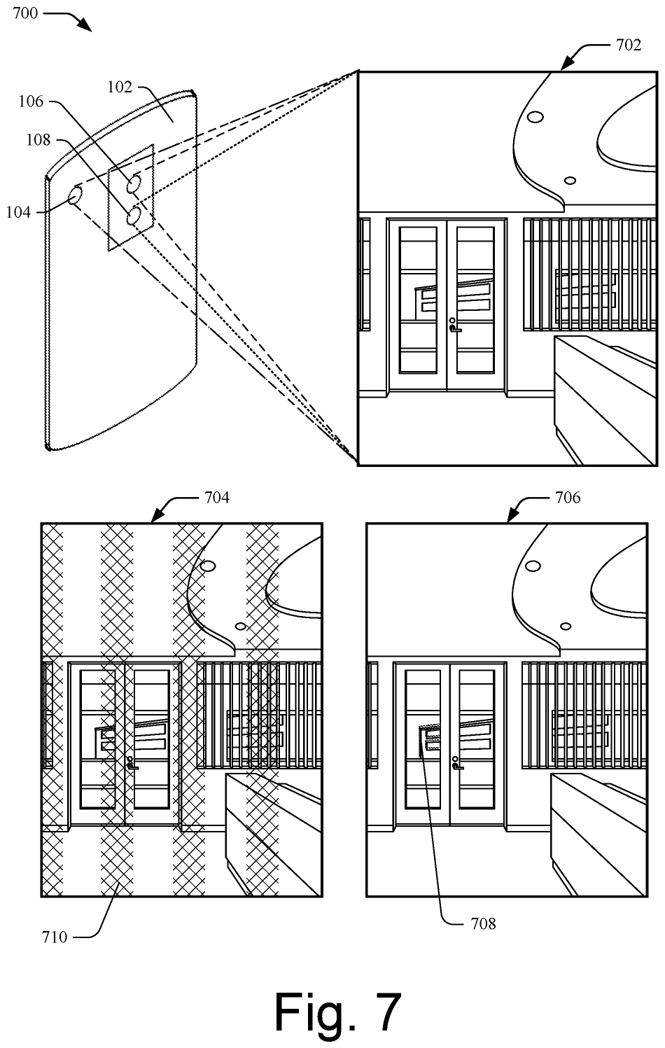

FIG. 7 illustrates an example implementation 700 of an anti-banding aspect of exposure control for an image-capture device. As illustrated, the computing device 102 may utilize the sensors 104 to determine a likelihood of exposure-related defects in a scene to be captured 702. The likelihood of exposure-related defects in a scene to be captured 702 may include a banding defect 710. A banding defect may be created because of the frequency at which light which illuminates a scene operates. The computing device 102 may utilize the first image-capture device 106 and the second image-capture device 108 to capture a first image 704 and a second image 706 of the scene to be captured 702. Additionally, due to long exposure time, a blur defect may be present in one or more images.

The computing device 102 captures sensor data describing the scene to be captured 702 through the sensors 104. In this example, a flicker sensor may be particularly beneficial to detect the presence of light flickering at a predetermined frequency. The sensor data may be used to determine a likelihood of exposure-related defects in a scene to be captured 702. The exposure-related defects may include a banding defect 710, which may be a dark band in an image caused by a flickering of light within the scene to be captured 702 due to the frequency at which lights operate, such as florescent lighting.

As noted above, the exposure controller 306 determines, based on the likelihood of exposure-related defects like banding of FIG. 7, a first exposure time and a second, longer exposure time. The exposure controller 306 then causes the first image-capture device 106 and the second image-capture device 108 to capture the first image 704 and the second image 706 with the respective exposure times.

The first exposure time may be a short exposure time determined to decrease the blur defect 708 in a portion of the scene to be captured 702. One example of the blur defect 708 may be a portion of the scene that, when captured with a longer exposure time, appears less clear due to lighting. The second exposure time may be a longer exposure time of at least 8.33 milliseconds (ms) determined to decrease the banding defect 710 in a portion of the scene to be captured 702. An exposure time of at least 8.33 ms is determined to be sufficient to capture an image without a banding defect based on the standard operating frequency of most lights. By so doing, the exposure controller 306 works with the image-merging module 202 to provide a band-free image.

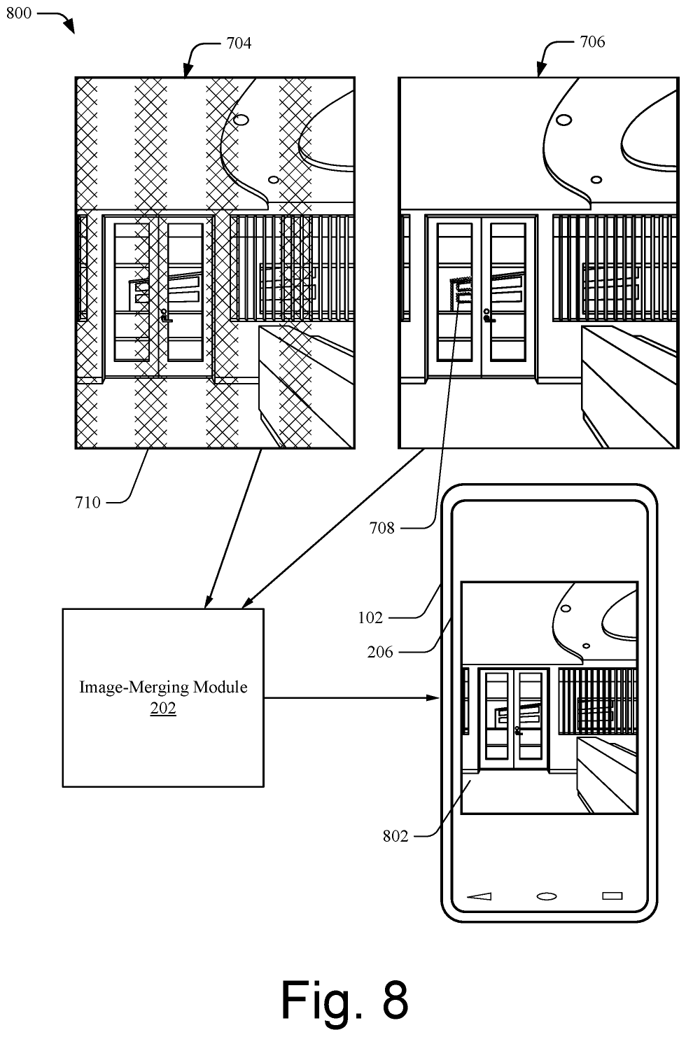

FIG. 8 illustrates an aspect 800 of an image-merging module 202 for the anti-banding implementation 700 of FIG. 7. As illustrated, the image-merging module 202 receives and incorporates the first image 704 to decrease the blur defect 708 and the second image 706 to decrease the banding defect 710 in a single image 802 of the scene to be captured (e.g., scene to be captured 702).

In an aspect, the first image 704 and the second image 706 are provided to the image-merging module 202. The image-merging module 202 creates the single image 802 of the scene to be captured (e.g., scene to be captured 702) by incorporating the first image 504 to decrease the blur defect 708 and incorporating the second image 706 to decrease the banding defect 710.

### Example Methods

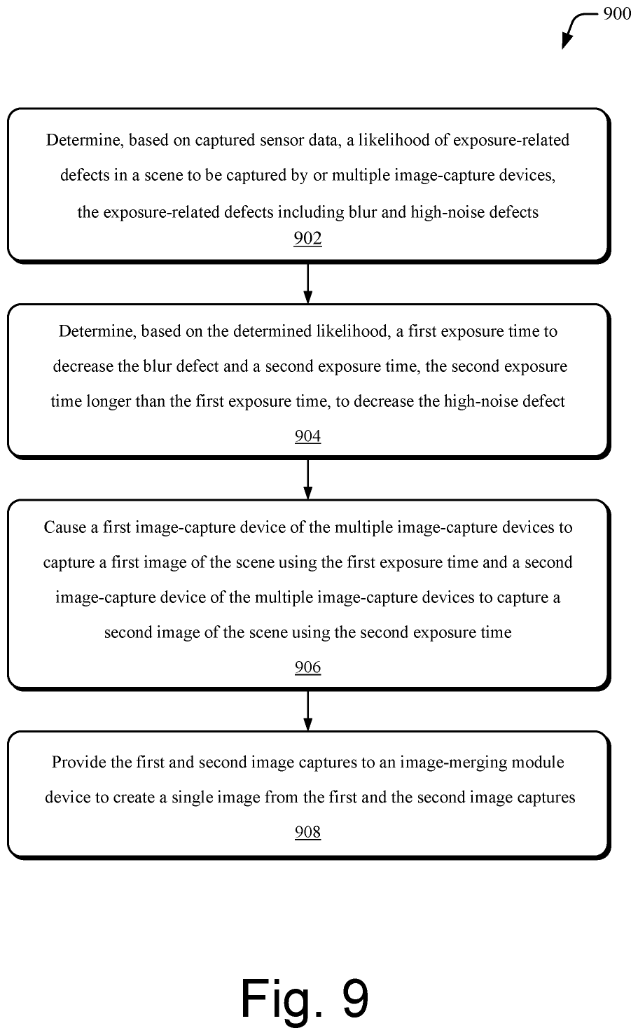

FIG. 9 illustrates an example method 900 of exposure control for an image-capture device. Through use of an exposure controller, a computing device determines a likelihood of exposure-related defects in a scene to be captured by image-capture devices 902. In this example, exposure-related defects may include a blur defect and a high-noise defect, though other defects, such as banding defects, can also be reduced or corrected by the techniques.

At 904, an exposure controller may determine, based on the determined likelihood of exposure-related defects, a first exposure time to decrease the blur effect and a second, longer exposure time to decrease the high-noise defect.

In one aspect, the determination of either: a likelihood of exposure-related defects; or the exposure times, may be done through machine learning. In another aspect, the previous steps may be performed through a decision tree or any other computational method.

At 906, the determination of the first and second exposure time may cause the first and second image-capture devices to capture the first and the second image of the scene using the first and second exposure time, respectively.

At 908, the first and second images are provided to the image-merging module, which may use the first and second images to create the single image. Optionally, additional images may be captured using additional image-capture devices with additional exposure times. In this example, all additional image captures may be provided to the image-merging module and used to create the single image.

In another example, the determination of the likelihood of exposure-related defects may determine a likelihood of a banding defect within the image. As a result, the second image may be a band-free image captured with the second image-capture device using a second exposure time of at least 8.33 ms. This exposure time meets the minimum requirements to remove the banding defect caused by the frequency at which most lights operate.

In another example, the determination of the likelihood of exposure-related defects may determine an object of focus. In this example, the second image may be used to create a motion-scene in the background portion of the scene.

Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, including, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

Some examples are described below:
Example 1: A method comprising: determining, based on captured sensor data, a likelihood of exposure-related defects in a scene to be captured by multiple image-capture devices, the exposure-related defects including blur and high-noise defects; determining, based on the determined likelihood, a first exposure time to decrease the blur defect and a second exposure time, the second exposure time longer than the first exposure time, to decrease the high-noise defect; causing a first image-capture device of the multiple image-capture devices to capture a first image of the scene using the first exposure time and a second image-capture device of the multiple image-capture devices to capture a second image of the scene using the second exposure time; and providing the first and second image captures to an image-merging module to create a single image from the first and second image captures.
Example 2: The method as recited by example 1 further comprising: using additional image-capture devices to capture one or more additional image captures of the scene, and providing the first and second image captures provides the additional image captures to the image-merging module.
Example 3: The method as recited by example 1, wherein the determining the likelihood of the exposure-related defects is determined, at least partially, through machine learning based on previous image captures.
Example 4: The method as recited by example 1 wherein, the determining the first or second exposure times is determined, at least partially, through machine learning based on previous image-captures captured using different exposure times.
Example 5: The method as recited by example 1, wherein the determining the likelihood of exposure-related defects is determined by a decision tree, the decision tree used to determine, based on the captured sensor data, the likelihood of exposure-related defects.
Example 6: The method as recited by example 1, wherein, the determining the first or second exposure time is determined by a decision tree, the decision tree usable to determine, based on the likelihood of exposure-related defects, the first or second exposure time.
Example 7: The method as recited by example 1, wherein the first and second image captures are captured at a same brightness, wherein the brightness is defined by a sensor gain multiplied by an exposure time.
Example 8: The method as recited by example 1, wherein the sensor data includes non-imaging data collected from an accelerometer.
Example 9: The method as recited by example 1, wherein the sensor data includes radar data collected from a radar system, the radar data usable to determine movement in the scene to be captured.
Example 10: The method as recited by example 1, wherein the sensor data includes non-imaging data collected from a flicker sensor usable to determine a banding defect in the scene to be captured.
Example 11: The method as recited by example 10, wherein causing the second image-capture device to capture the second image at the second exposure time causes the second exposure time to be greater than a time associated with a frequency of flickering of light within the scene to be captured, the frequency collected by the flicker sensor.
Example 12: The method as recited by example 11, wherein the second exposure time is at least 8.33 milliseconds and the second image is a band-free image.
Example 13: The method as recited by example 1, wherein the sensor data is imaging data collected by one or more of the multiple image-capture devices.
Example 14: The method as recited by example 13, further comprising: determining an object of focus based on the sensor data and using the image-merging module to create the single image of the scene by incorporating the first image capture for the object of focus and incorporating the second image capture for a remaining background portion of the scene.
Example 15: The method as recited by example 1 or 14, wherein the second image capture is incorporated to create a motion-scene in the background portion, the motion scene in the background portion being a blurred image-capture indicating motion within the scene.
Example 16: The method as recited by example 1, wherein the first and second image captures are multi-frame image captures, and the single image created by the image-merging module is a multi-frame image, the multi-frame image including multiple single-frame image captures captured in succession.
Example 17: The method as recited by any of the preceding examples, further comprising displaying the single image created from the image-merging module digitally.
Example 18: A computing device comprising: one or more processors; one or more image-capture devices; one or more sensors, the sensors capable of capturing the captured sensor data; and memory storing instructions that, when executed by the one or more processors, cause the one or more processors to implement the method described within this document.

### Conclusion

Although aspects of exposure control for image-capture have been described in language specific to features and/or methods, the subject of the appended claims is not necessarily limited to the specific features or methods described. Rather, the specific features and methods are disclosed as example implementations of the claimed exposure control for an image-capture device, and other equivalent features and methods are intended to be within the scope of the appended claims. Further, various aspects are described, and it is to be appreciated that each described aspect can be implemented independently or in connection with one or more other described aspects.

1. A method comprising:
determining, based on captured sensor data, a likelihood of exposure-related defects in a scene to be captured by multiple image-capture devices, the exposure-related defects including blur and high-noise defects;
determining, based on the determined likelihood, a first exposure time to decrease the blur defect and a second exposure time, the second exposure time longer than the first exposure time, to decrease the high-noise defect;
causing a first image-capture device of the multiple image-capture devices to capture a first image of the scene using the first exposure time and a second image-capture device of the multiple image-capture devices to capture a second image of the scene using the second exposure time; and
providing the first and second image captures to an image-merging module to create a single image from the first and second image captures.

2. A method described in claim 1, wherein one or more additional image-capture devices are used to capture one or more additional image captures of the scene, and wherein providing the first and second image captures provides the additional image captures to the image-merging module.

3. A method described in claim 1, wherein determining the likelihood of the exposure-related defects is determined, at least partially, through machine learning based on previous image captures.

4. A method described in claim 1, wherein determining the first or second exposure time is determined, at least partially, through machine learning based on previous image-captures captured using different exposure times.

5. A method described in claim 1, wherein the first and second image captures are captured at a same brightness and wherein the brightness is defined by a sensor gain multiplied by an exposure time.

6. A method described in claim 1, wherein the sensor data includes non-imaging data collected from a radar system usable to determine movement in the scene to be captured.

7. A method described in claim 1, wherein the sensor data includes non-imaging data collected from a flicker sensor usable to determine a banding defect in the scene to be captured.

8. A method described in claim 7, wherein causing the second image-capture device to capture the second image at the second exposure time causes the second exposure time to be greater than a time associated with a frequency of flickering of light within the scene to be captured, the frequency collected by the flicker sensor.

9. A method described in claim 8, wherein the second exposure time is at least 8.33 milliseconds and the second image is a band-free image.

10. A method described in claim 1, wherein the sensor data is imaging data collected by the image-capture device.

11. A method described in claim 1, further comprising determining an object of focus based on the sensor data and further comprises using the image-merging module to create the single image of the scene by incorporating the first image capture for the object of focus and incorporating the second image capture for a remaining background portion of the scene.

12. A method described in claim 11, wherein the second image capture is incorporated to create a motion scene in the background portion, the motion scene in the background portion being a blurred image-capture indicating motion within the scene.

13. A method described in claim 1, wherein the first and second image captures are multi-frame image captures, and the single image created by the image-merging module is a multi-frame image, the multi-frame image including multiple single-frame image captures captured in succession.

14. A method described in claim 1, further comprising displaying the single image created from the image-merging module.

15. A computing device comprising:
one or more processors;
one or more image-capture devices;
one or more sensors, the sensors capable of capturing the captured sensor data; and
memory storing instructions that, when executed by the one or more processors, cause the one or more processors to:
determine, based on captured sensor data, a likelihood of exposure-related defects in a scene to be captured by multiple image-capture devices, the exposure-related defects including blur and high-noise defects;
determine, based on the determined likelihood, a first exposure time to decrease the blur defect and a second exposure time, the second exposure time longer than the first exposure time, to decrease the high-noise defect;
cause a first image-capture device of the multiple image-capture devices to capture a first image of the scene using the first exposure time and a second image-capture device of the multiple image-capture devices to capture a second image of the scene using the second exposure time; and
provide the first and second image captures to an image-merging module to create a single image from the first and second image captures.
